(19) United States
(12) Patent Application Publication
(10) Pub. No.: US 2009/0321363 A1
(43) Pub. Date: Dec. 31, 2009

(54) FUNCTIONAL PARTICLES AND WATER TREATMENT METHOD EMPLOYING THE SAME

(75) Inventors: Shinji Murai, Sagamihara-Shi (JP); Tatsuoki Kono, Tokyo (JP); Shinetsu Fujieda, Kawasaki-Shi (JP); Taro Fukaya, Kawasaki-Shi (JP); Hideyuki Tsuji, Yokohama-Shi (JP); Akiko Suzuki, Tokyo (JP); Nobuyuki Ashikaga, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/405,430

(22) Filed: Mar. 17, 2009

(30) Foreign Application Priority Data
Jun. 27, 2008 (JP) 2008-168339

(51) Int. Cl. C02F 1/48; H01F 1/01; H01F 1/42

(52) U.S. Cl. 210/695; 252/62.51 R; 252/62.56

(57) ABSTRACT

The present invention provides functional particles capable of effectively adsorbing impurities in water treatment. The particles can be rapidly separated by use of magnetic force, and hence are excellent in workability. They are magnetic particles having surfaces modified with amphipathic groups loaded thereon. The amphipathic group comprises an ammonium or carboxylate group as a hydrophilic moiety and a hydrocarbon group as a hydrophobic moiety. The hydrophobic moiety has a function of adsorbing the impurities, and the hydrophilic moiety has a function of dispersing the particles stably in water.

### CROSS-REFERENCE TO RELATED APPLICATION

This application is based upon and claims the benefit of priority from the prior Japanese Patent Application No. 168339/2008, filed on Jun. 27, 2008; the entire contents of which are incorporated herein by reference.

### BACKGROUND OF THE INVENTION

1. Field of the Invention

The present invention relates to functional particles advantageously used for water purification or for solid-liquid separation. This invention particularly relates to functional particles with which substances to separate are combined to be caught and removed from raw water by use of magnetic separation technology.

2. Background Art

Recently, according as industries have been developed and the population has been increased, it has become desired to use water resources effectively. Accordingly, it has become very important to reuse abandoned water such as industrial wastewater. For the purpose of that, it is necessary to purify water, namely, to separate impurities from water. There are known various methods of separating impurities from water. Examples of the known separation methods include membrane separation, centrifugal separation, active carbon adsorption, and ozone treatment. Further, floating substances can be removed by use of flocculants. Those methods can remove not only oils and/or clay dispersed in water but also eco-harmful chemicals such as phosphorus or nitrogen compounds contained in water. Among the above, the membrane separation is one of the most popularly used methods. However, if oils dispersed in water are removed with a membrane, pores of the membrane are often clogged with the oils and hence the working lifetime of the membrane is liable to shorten. The membrane separation is, therefore, often unsuitable for removing oils from water. When water is polluted with oils such as heavy oil, buoyancy of the oils can be exploited to remove them. For example, heavy oil floating on water surface is brought together with oil fences extended in the water and then sucked up to be recovered from the water surface, or otherwise heavy oil-adsorbent of hydro-phobic material is spread on the water surface so that the heavy oil can be adsorbed and thereby recovered.

Meanwhile, there is known a water purification apparatus of solid-liquid separation type. The apparatus comprises a filter through which raw water is filtrated to separate and remove impurities such as organic substances or other foreign substances (which are hereinafter simply referred to as “impurities”). In the purification apparatus, the raw water is led to pass through the filter having fine pores. If the impurities have projected areas (or projected diameters) larger than the pores, they are caught by the filter and, as a result, water having passed through the filter is purified and collected. However, if this purification treatment is repeatedly carried out with the same filter, the caught impurities are gradually accumulated on the inlet side of the filter and accordingly pressure loss increases to lower the amount of filtrated water. In that case, it is necessary to stop the treatment and to pour purified water reversely so as to wash away and remove the accumulated impurities.

In the case where too fine impurities to remove with the filter must be separated, they are made to cohere with flocculants to form aggregations having enough sizes to catch by the filter (namely, sizes of a few hundred micrometers) and then the aggregations are removed with the filter. For example, flocculants such as aluminum sulfate and poly aluminum chloride are added into raw water to generate aluminum ions in the raw water, and then the water is stirred to aggregate the impurities. Since the impurities cohere to become relatively large aggregations, they can be removed with the filter to obtain purified water having high quality. The separated impurities in the form of aggregations are treated as sludge, which is composted or otherwise is directly conveyed to a landfill site or an incineration plant.

However, the above filter-separation method has some problems to solve.

First, since washing water is made to flow reversely to wash away the impurities accumulated on the filter, the obtained sludge is a mixture of the impurities and the washing water. Accordingly, the sludge produced in the method generally contains a large amount of water. On the other hand, however, the sludge preferably contains water in an amount as small as possible to reduce the conveying cost whether it is composted or directly trucked to a landfill site or an incineration plant. The sludge is, therefore, generally drained with a drying or wringing device such as a spin-dryer or a belt-pressing machine. If the sludge contains water in a large amount, a device capable of draining a large amount of water is needed and hence it costs a lot to buy and run the device.

Further, when the above separation method is performed successively, the filtration process (in which the impurities are gradually accumulated on the filter) and the cleaning process (in which the impurities accumulated on the filter are washed away) must be alternatively repeated. This means that the filtration process must be periodically interrupted to lower the amount of treated water.

Furthermore, in order to treat a large amount of raw water, a large filter is required and hence the purification apparatus must be inevitably enlarged. In addition, from the viewpoint of cost, it is disadvantageous to use flocculants.

As described above, there is room for improvement in the filter-separation method.

JP-A 2000-176306 (KOKAI) discloses a method in which heavy oil is recovered by means of a magnetic separation apparatus. The disclosed method employs magnetic particles which are coated with hydrophobic layers and thereby which are made capable of adsorbing oils. In the method, first those oil-adsorbent particles are spread on raw water to adsorb impurities, namely, to catch heavy oil floating on water. The particles having adsorbed the heavy oil is then pumped up together with the water, and collected by means of a magnetic separation-purification apparatus to recover the heavy oil. Here, the “magnetic separation-purification apparatus” means a device with which the magnetic particles are collected and recovered by use of magnetic force.

The magnetic separation-purification apparatus thus separates and recovers the magnetic particles by use of magnetic force. In addition to the above process, the apparatus can be also used for another purification process. In the process, magnetic particles not coated with hydrophobic layers are added into raw water together with flocculants, so that the magnetic particles serve as nuclei and thereby non-magnetic substances contained in the water are made to cohere around the magnetic particles to form aggregations, which are then separated and recovered with the magnetic separation apparatus by use of magnetic force. In this way, even the magnetic particles not coated with hydrophobic layers can be separated and recovered by the magnetic separation process only if they are pretreated.

However, the inventors have studied and found that there is room for improvement. It is found that the magnetic particles coated with hydrophobic layers disclosed in JP-A 2000-176306 (KOKAI) are insufficiently dispersed in raw water since they have hydrophobic surfaces. The insufficiently dispersed particles cannot adsorb the impurities sufficiently, and hence the impurities are liable to be removed insufficiently.

### SUMMARY OF THE INVENTION

The functional particles according to the present invention are characterized by comprising magnetic particles and amphipathic groups loaded on the surfaces of said magnetic particles.

Further, the water treatment method according to the present invention is characterized by comprising the steps of:

dispersing the above functional particles in water containing impurities, so that said impurities are adsorbed on the surfaces of said functional particles; and then

collecting and recovering said functional particles having adsorbed the impurities by use of magnetic force

The present invention provides functional particles advantageously used for water treatment. The functional particles can efficiently adsorb impurities, particularly, organic foreign substances in raw water, and after adsorbing the impurities they can be rapidly separated from the water by use of magnetic force. The functional particles of the present invention, therefore, are excellent in workability. Further, the present invention also provides a water treatment method of high efficiency and of low cost. In the water treatment method, the above functional particles are employed to adsorb foreign substances floating on raw water. Although the particles having adsorbed the impurities are dispersed evenly in the water, they can be readily gathered to one point by applying magnetic force. This means that the functional particles can be used not only for purifying water but also for recovering aimed substances floating on water.

The functional particles according to the present invention have high affinity to both water and oils (impurities) since amphipathic groups are loaded on the surfaces thereof. The hydrophobic (oleophilic) moieties of the amphipathic groups combine the impurities with the particles, and the hydrophilic moieties have a function of dispersing the particles very stably in water. Consequently, the functional particles having adsorbed the impurities are stably dispersed in water to form a suspension, and hence the impurities can be effectively recovered by use of magnetic force.

### DETAILED DESCRIPTION OF THE INVENTION

### Functional Particles

The functional particles according to the present invention comprise magnetic particles and amphipathic groups loaded on the surfaces thereof. The magnetic particles used in the functional particles are not particularly restricted as long as they contain magnetic substances. The magnetic substances are preferably materials exhibiting ferromagnetism at room temperature, but they by no means restrict embodiments of the present invention. Accordingly, any ferromagnetic material can be employed. Examples of the ferromagnetic material include iron, iron alloy, magnetite, ilmenite, pyrrhotite, magnesia ferrite, cobalt ferrite, nickel ferrite, and barium ferrite. Among them, ferrites having excellent stability in water are preferred because the object of the present invention can be effectively achieved. For example, magnetite (Fe₃O₄) is not only inexpensive but also stable in water, and further does not contain harmful elements. That is, hence, advantageously used for water treatment. The magnetic particles are generally in various shapes such as spheres, polyhedrons and irregular forms, but there is no particular restriction on the particle shapes. The sizes and shapes of the magnetic particles can be properly selected in consideration of production cost and other conditions. However, the shapes of the particles are preferably spheres or poly-hedrons having round corners. The magnetic particles may be subjected to plating treatment such as Cu plating or Ni plating, if necessary.

In the present invention, the magnetic particles do not need to consist of only the magnetic substances. For example, they may comprise very fine magnetic powder combined with a resin binder. Further, the magnetic particles may be subjected to surface treatment for the purpose of, for example, anti-corrosion. It is only required of the magnetic particles that the resultant functional particles contain enough magnetic substances to be collected and recovered by use of magnetic force in the water treatment described later.

There is no particular restriction on the mean size of the magnetic particles, but it is normally 0.1 to 1000 μm, preferably 10 to 500 μm. If the mean particle size is too small, the particles in a magnetic field may undergo too weak magnetic force to be collected and recovered. On the other hand, however, if it is too large, the particles may have such small specific surface areas as to lower efficiency of recovering the impurities. In the present invention, the mean particle size can be determined by laser diffraction. For example, it can be measured by means of an injection type dry measurement unit (SALD-DS21 [trademark], available from Shimadzu Corp.). Further, it can be also determined by other measurements such as X-ray diffraction and transmission electron microscopy (TEM).

The functional particles of the present invention are magnetic particles having surfaces modified with amphipathic organic groups loaded thereon. The “amphipathic organic group” means an organic group comprising a hydrophobic or oleophilic moiety and a hydrophilic moiety in combination.

The hydrophobic moiety is generally a hydrocarbon chain, which may be either an aliphatic hydrocarbon chain or an aromatic one. On the other hand, the hydrophilic moiety is a group of relatively high polarity. Examples of the hydrophilic moiety include an ammonium group (—N⁺R¹R²R³: each of R¹ to R³ is hydrogen or a hydrocarbon group provided that at least one of them is a hydrocarbon group), a carboxylate group (RCOO—N⁺HR⁴R⁵: R is a hydrocarbon group and each of R⁴ and R⁵ is hydrogen or a hydrocarbon group), carboxyl, hydroxyl, sulfonic acid group, and phosphoric acid group.

The amphipathic group used in the present invention comprises the above hydrophobic and hydrophilic moieties in combination. This means that the amphipathic group in the present invention is a hydrocarbon chain connecting to a hydrophilic group. There is no particular restriction on the position where the hydrophilic group is connected. However, the hydrophilic group is preferably placed near the magnetic particle when the amphipathic group is attached on the particle. If the functional particles individually having that structure are dispersed in raw water, impurities in the water can be caught by the hydrophobic moieties extended from the magnetic particles while the hydrophilic groups near the particles can keep the particles dispersed stably in the water. Particularly if the particles have long hydrophobic moieties, the impurities are involved and captured in the hydrophobic moieties and hence are hard to be released. Accordingly, the particles preferably have long hydrophobic moieties.

The amphipathic groups can be loaded onto the surfaces of the magnetic particles by any method. However, if the amphipathic groups are released from the magnetic particles when the functional particles are dispersed in raw water, they may contaminate the water. It is, therefore preferred that the amphipathic groups be chemically combined with the surfaces of the magnetic particles firmly enough not to be released. In view of that, organic substances having the amphipathic groups may be directly reacted with the surfaces of the magnetic particles.

In the case where the magnetic particles consist of only the magnetic substances such as magnetite, there are oxygen atoms of the oxide positioned on the surfaces. Accordingly, the surfaces may be properly treated to load hydroxyls thereon so that the amphipathic groups or precursor organic compounds thereof can be readily reacted. Examples of the treatment applied to the surfaces of the magnetic particles include washing with organic solvents such as ethanol, UV washing, and plasma treatment.

On the other hand, in the case where the magnetic particles comprise very fine magnetic powder combined with a resin binder, functional groups reactable with the organic substances can be beforehand introduced into the binder so that the amphipathic groups may be chemically combined with the magnetic particles.

Further, the surfaces of the magnetic particles may be treated with a silane coupling agent. In this method, first the coupling agent is reacted and chemically combined with the surfaces. Thereafter, the organic substances having the amphipathic groups are reacted with the coupling agent combined with the surfaces, or otherwise the coupling agent itself serves as the precursor of the amphipathic groups. The coupling agent as the precursor is reacted with another organic substance to form the amphipathic groups. This method is preferred because the amphipathic groups can be enough firmly fixed on the surfaces of the magnetic particles to protect the raw water from the reverse contamination.

In the case where the coupling agent is used for loading the amphipathic groups onto the surfaces of the magnetic particles, the surfaces are preferably beforehand treated, for example, by washing to form hydroxyls thereon before the coupling agent is reacted, as described above. The treatment applied to the surfaces for forming hydroxyls is preferably washing with alcohol because it is simple and easy to perform.

In consideration of reactivity and bonding strength to the surfaces of the magnetic particles, the coupling agent is preferably a silane coupling agent containing alkoxysilyl groups. Further, in consideration of reactivity to the organic substances having the amphipathic groups, the silane coupling agent preferably contains functional groups reactable with the organic substances. Examples of the functional groups reactable with the organic substances include amino groups, amine groups, hydroxyl, carboxyl, and halogenated alkyl groups. Examples of the silane coupling agent containing amino groups or amine groups include 3-aminopropyltriethoxysilane, N-2-amino-ethyl-3-aminopropylmethyldimethoxysilane, N-2-amino-ethyl-3-aminopropyltrimethoxysilane, N-2-aminoethyl-3-amino-propyltriethoxysilane, 3-aminopropyltrimethoxysilane, 3-tri-ethoxysilyl-N-(1,3-dimetyl-butylidene)propylamine, N-phenyl-3-aminopropyltrimethoxysilane, and 3-chloropropyl-trimethoxysilane. Among them, 3-aminopropyltriethoxysilane is particularly preferred.

The surfaces of the magnetic particles are treated with those silane coupling agents containing amino groups so as to load the amino groups thereon, and then the amino groups are reacted with halogenated hydrocarbons having hydrocarbon chains (namely, hydrophobic moieties). Thus, the amphipathic groups are loaded onto the surfaces of the magnetic particles. The amphipathic groups thus formed by the above reactions comprise ammonium salt structures near the magnetic particles, and the ammonium salt structures are combined with the hydro-carbon chains. The amphipathic groups are, therefore, ammonium groups combined with hydrocarbon groups. In the same manner, the amino groups can be reacted with carboxylic acids having hydrocarbon chains so as to form amphipathic groups having amino-carboxyl ionic bonds near the magnetic particles. The ionic bonds are combined with the hydrocarbon chains. Accordingly, the amphipathic groups thus obtained are carboxylate groups combined with hydrocarbon groups.

The halogenated hydrocarbons usable in the above method are, for example, halogenated aliphatic hydrocarbons or halogenated aromatic ones. Examples of the halogenated aliphatic hydrocarbons include halogen-substituted straight- or branched-hydrocarbons such as heptanes, octane, nonane, decane, undecane, dodecane, tridecane, tetradecane, penta-decane, hexadecane, heptadecane, octadecane, nonadecane, icosane, henicosane, docosane, tricosane, tetracosane, pentacosane, hexacosane, heptacosane, octacosane, nona-cosane, and triacosane. Among them, particularly preferred is a primary halogenated aliphatic hydrocarbon in which a halogen atom is positioned at the terminal of the saturated or unsaturated hydrocarbon chain. The halogen atom may be any of fluorine, chlorine, bromine and iodine, but particularly preferred are chlorine, bromine and iodine.

Examples of the halogenated aromatic hydrocarbons include benzyl chloride, 1,2-, 1,3- or 1,4-dichlorobenzene, 1- or 2-chlorobenzene, 9-chloromethylanthracene, and 1,4- or 1,5-dichloronaphthalene. The chlorine atom in those compounds may be replaced with fluorine, bromine or iodine atom.

In the case where amino groups are reacted with carboxylic acids to form the amphipathic groups, the carboxylic acids may be saturated aliphatic ones, unsaturated aliphatic ones or aromatic ones. Examples of the saturated aliphatic carboxylic acids include monocarboxylic acids such as acetic acid, propionic acid, butanoic acid, pentanoic acid, hexanoic acid, heptanoic acid, octanoic acid, nonanoic acid, decanoic acid, tetradecanoic acid, pentadecanoic acid, hexadecanoic acid, heptadecanoic acid, octadecanoic acid, nonadecanoic acid, icosanoic acid, docosanoic acid, tetradocosanoic acid, hexa-docosanoic acid and octadocosanoic acid; dicarboxylic acids such as oxalic acid, malonic acid, succinic acid, glutaric acid, adipic acid, pimelic acid, suberic acid, azelaic acid and sebacic acid; and polymeric carboxylic acids such as polymethacrylic acid and polyacrylic acid. If the carboxylic acid has two or more carboxyls, it is presumed that each carboxyl reacts with amino group and thereby that the hydrophobic moiety of the carboxylic acid is combined with the amino group at each terminal.

Examples of the unsaturated aliphatic carboxylic acids include 9-hexadecenoic acid, cis-9-octadecenoic acid, cis,cis-9,12-octadecadienoic acid, 9,12,15-octadecatrienoic acid, 6,9,12-octadecatrienoic acid, 6,11,13-octadecatrienoic acid, 8,11-icosadienoic acid, 5,8,11-icosatrienoic acid, 5,8,11-icosa-tetraenoic acid, and cis-15-tetradocosanoic acid.

Examples of the aromatic carboxylic acids include monocarboxylic acids such benzoic acid, methylbenzoic acid, xylylic acid, prehnitylic acid, γ-isodurylic acid, β-isodurylic acid, α-isodurylic acid, α-toluic acid, hydrocinamic acid, salicylic acid, o-, m- or p-anisic acid, 1-naphthalenecarboxylic acid, 2-naphthalenecarboxylic acid and 9-anthracenecarboxylic acid; dicarboxylic acids such as phthalic acid, isophthalic acid and terephthalic acid; and polycarboxylic acids such as hemimellitic acid, trimellitic acid, trimesic acid, mellophanic acid, prehnitic acid and pyromellitic acid.

The hydrophobic groups of the organic substances such as carboxylic acids are, for example, aliphatic groups containing 8 to 30, preferably 10 to 18 carbon atoms or aromatic groups containing 6 or more, preferably 8 or more carbon atoms. Here, the number of carbon atoms includes carbon atoms in carboxyls if the organic substances are carboxylic acids.

The coupling agents may contain hydroxyls instead of amino groups. In that case, some of the hydroxyls can be reacted with halogenated hydrocarbons having hydrophobic hydrocarbon groups, and thereby combinations of the hydro-philic groups and the hydrophobic groups can be loaded onto the surfaces of the magnetic particles. The other hydroxyls not reacted with the halogenated hydrocarbons are left on the surfaces of the resultant functional particles, and can serve as the hydrophilic groups.

### Water Treatment Method

The water treatment method according to the present invention is used for separating impurities from raw water containing them. Here, the “impurities” means substances that are contained in water to treat and that must be removed so as to reuse the water. Further, in the present specification, organic substances to separate from raw water are referred to as “impurities” for the sake of convenience, but they may be collected for reuse.

In the present invention, organic substances such as oils in raw water are adsorbed with hydrophobic moieties of the amphipathic groups loaded on the surfaces of the functional particles. Accordingly, the water treatment method of the present invention is suitable for purifying water containing organic impurities, particularly, oils. Here, the “oils” means oils and fats that are generally liquid at room temperature, that are only slightly soluble in water, that have relatively high viscosities and that have specific gravities lower than water. They are, for example, animal and vegetable fats and oils, hydrocarbons, and aromatic oils. Representative examples of them include fatty acid glycerides, petroleum and higher alcohols. Those oils are characterized by functional groups contained therein, and hence it is preferred to select hydrophobic group contained in the functional particles in accordance with the functional groups.

In the water treatment method according to the present invention, first the aforementioned functional particles are dispersed in raw water containing the impurities described above. The functional particles have amphipathic groups loaded on their surfaces, and the amphipathic groups comprise hydrophobic moieties having affinity to the impurities. Accordingly, the impurities are adsorbed on the functional particles. The functional particles of the present invention have very high adsorption ratio although it depends upon the concentration of the impurities and the amount of the particles. If a sufficient amount of the functional particles are used, the impurities are adsorbed to the surface of the functional particles in an amount of generally 80% or more, preferably 97% or more, more preferably 98% or more, most preferably 99% or more.

After the impurities are adsorbed, the functional particles are then collected and recovered to remove the impurities from the water. In this step, magnetic force is used to collect the particles. Since the cores of the functional particles are magnetic particles, they are attracted by magnetic force and thereby the functional particles can be easily collected and recovered. In combination with the magnetic force, sedimentation by gravity or centrifugal force in a cyclone can be used to separate the particles. The separation in this combination improves workability and hence makes it possible to recover the impurities rapidly.

There is no particular restriction on the water to treat. The water treatment method according to the present invention can be practically applied to industrial wastewater, sewage, and domestic wastewater. There is also no particular restriction on the concentration of impurities in the water. However, if the impurities are too thickly contained, it is necessary to use a large amount of the functional particles. Accordingly, in that case, it is preferred to lower the concentration of impurities by another method before the water treatment so that the functional particles can work effectively. The concentration of impurities is preferably 1% or less, more preferably 0.1% or less.

After the water treatment, the recovered functional particles can be reclaimed and reused. In order to reclaim the particles, it is necessary to remove the adsorbed impurities from the surfaces of the particles. For removing the impurities, the particles are preferably washed with solvents. The solvents preferably do not destroy the amphipathic groups on the particle surfaces but dissolve the impurities. Examples of the solvents include methanol, ethanol, n-propanol, iso-propanol, acetone, tetrahydrofuran, n-hexane, cyclohexane, and mixtures thereof. Further, other solvents can be also used according to the impurities and the amphipathic groups.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

The present invention is further explained by use of the following examples, but they by no means restrict the present invention.

### Example 1

Magnetic particles (mean particle size: 10 μm) were prepared. First, the surfaces thereof were washed to form hydroxyls. The magnetic particles were added in ethanol, and stirred at room temperature. The mixture was subjected to centrifugal separation at 5000 rpm for 3 minutes, and then the supernatant was removed. The precipitate was washed with ultra pure water three times, and dried at 100° C. for 30 minutes to remove water completely.

Secondly, the thus-treated magnetic particles were reacted with 3-aminopropyltriethoxysilane. To 3 g of the washed magnetic particles, 3-aminopropyltriethoxysilane in excess was added and reacted at room temperature for 10 hours. After the reaction was completed, un-reacted 3-amino-propyltriethoxysilane was washed away with ethanol three times and then with ultra pure water three times.

The magnetic particles thus subjected to the surface treatment were observed by an IR measurement apparatus in accordance with the attenuated total refraction (ATR) method. As a result, the obtained spectrum exhibited the peaks attributed to Si—O (800 to 1100 cm⁻¹) and O—H (3500 to 3900 cm⁻¹).

Further, the peak attributed to C—H (2982 to 2822 cm⁻¹) given by 3-aminopropyltriethoxysilane was also observed in the IR spectrum, and therefore it was confirmed that amino groups were attached via silyl groups on the surfaces of the particles.

The obtained surface-treated magnetic particles were then dispersed in anhydrous tetrahydrofuran (THF), and then octanoic acid in excess was added therein and stirred for 2 hours. After the reaction was completed, un-reacted octanoic acid was washed away with THF three times and then with ultra pure water three times, to obtain functional particles having surfaces with which the hydrophobic moiety of the carboxylic acid was combined via the coupling agent.

The mean particle size of the obtained functional particles was determined by X-ray diffraction measurement and by transmission electron microscopy (TEM) measurement, and thereby found to be 10 μm in both measurements. It was also confirmed that the above surface modification gave no effect on the shapes of the particles.

In a 50 mL color comparison tube, 20 mL of water, 70 μL of oil and 0.1 g of the above-obtained functional particles were placed. The tube was shaken for 1 minute, so that the oil was adsorbed on the particles. The light transmittance of the sample was then measured at 600 nm to evaluate the dispersability in water. As a result, the light transmittance was found to be 10%, and thereby it was confirmed that the particles were evenly dispersed.

The functional particles were collected and removed from the color comparison tube by means of a magnet. Thereafter, 10 mL of alternative fluorocarbon solvent (H-997 [trademark], available from Horiba, Ltd.) was added to abstract un-adsorbed oil, and then the concentration of the un-adsorbed oil was measured by an oil-content analyzer (OCMA-305 [trademark], available from Horiba, Ltd.). On the basis of the measured concentration of the un-adsorbed oil, the ratio of the un-adsorbed amount based on the initially added amount of the oil was calculated. As a result, the ratio of the un-adsorbed oil was found to be 2.9%.

### Example 2

The procedure of Example 1 was repeated except for replacing octanoic acid with decanoic acid, to synthesize and evaluate the functional particles.

### Example 3

The procedure of Example 1 was repeated except for replacing octanoic acid with tetradecanoic acid, to synthesize and evaluate the functional particles.

### Example 4

The procedure of Example 1 was repeated except for replacing octanoic acid with stearic acid, to synthesize and evaluate the functional particles.

### Example 5

The procedure of Example 1 was repeated except for replacing octanoic acid with benzoic acid, to synthesize and evaluate the functional particles.

### Example 6

The procedure of Example 1 was repeated except for replacing octanoic acid with 2-naphthalenecarboxylic acid, to synthesize and evaluate the functional particles.

### Comparative Example 1

The procedure of Example 1 was repeated except for replacing octanoic acid with propionic acid, to synthesize and evaluate the functional particles. Propionic acid has three carbon atoms, and hence did not give the hydrophobic group claimed in the present invention.

### Comparative Example 2

The procedure of Example 1 was repeated except for replacing octanoic acid with hexanoic acid, to synthesize and evaluate the functional particles. Hexanoic acid has six carbon atoms, and hence did not give the hydrophobic group claimed in the present invention

### Comparative Example 3

The magnetic particles treated in the first step of Example 1 were reacted with decanetriethoxysilane in the following manner. To 3 g of the washed magnetic particles, decanetriethoxysilane in excess was added and reacted at room temperature for 10 hours. After the reaction was completed, un-reacted decanetriethoxysilane was washed away with ethanol three times and then with ultra pure water three times. The obtained particles were evaluated in the same manner as in Example 1.

The results were as set forth in Table 1.

As a result, it was revealed that the obtained particles were excellent both in oil-adsorbability and in dispersability if carboxylic acids of 8 or more carbon atoms (in Examples 1 to 4) or aromatic carboxylic acids (in Examples 5 and 6) were used.

However, if the carboxylic acids of 6 or less carbon atoms (in Comparative Examples 1 and 2) were used, the particles poorly adsorbed the oil although they were excellent in dispersability. In contrast, the particles modified with alkyl groups having no functional groups (in Comparative Example 3) were poor in dispersability although they were excellent in oil-adsorbability.

TABLE 1

| | Ratio of un-adsorbed oil (%) | Dispersability |
|---|---|---|
| Ex. 1 | 2.9 | excellent |
| Ex. 2 | 2.0 | excellent |
| Ex. 3 | 1.8 | excellent |
| Ex. 4 | 1.8 | excellent |
| Ex. 5 | 6.0 | excellent |
| Ex. 6 | 2.9 | excellent |
| Com. 1 | 40.0 | excellent |
| Com. 2 | 34.0 | poor |
| Com. 3 | 3.0 | poor |

### Example 7

In the same manner as in Example 1, the magnetic particles were reacted with 3-aminopropyltriethoxysilane and then washed with ethanol and ultra pure water to obtain surface-treated magnetic particles. The obtained particles were dispersed in anhydrous tetrahydrofuran, and then 1-bromo-decane in excess was added therein and stirred for 2 hours. After the reaction was completed, un-reacted 1-bromodecane was washed away with THF three times and then with ultra pure water three times, to obtain functional particles having surfaces with which ammonium salts were combined.

The obtained functional particles were evaluated in the same manner as in Example 1.

### Example 8

The procedure of Example 7 was repeated except for replacing 1-bromodecane with 1-bromododecane, to synthesize and evaluate the functional particles.

### Example 9

The procedure of Example 7 was repeated except for replacing 1-bromodecane with 1-bromotetradecane, to synthesize and evaluate the functional particles.

### Example 10

The procedure of Example 7 was repeated except for replacing 1-bromodecane with stearyl bromide, to synthesize and evaluate the functional particles.

### Example 11

The procedure of Example 7 was repeated except for replacing 1-bromodecane with benzyl chloride, to synthesize and evaluate the functional particles.

### Example 12

The procedure of Example 7 was repeated except for replacing 1-bromodecane with 1-chloromethylnaphthalene, to synthesize and evaluate the functional particles.

### Comparative Example 4

The procedure of Example 7 was repeated except for replacing 1-bromodecane with 1-chlorobutane, to synthesize and evaluate the functional particles.

### Comparative Example 5

The procedure of Example 7 was repeated except for replacing 1-bromodecane with 1-chlorohexane, to synthesize and evaluate the functional particles.

The results were as set forth in Table 2.

As a result, it was revealed that the functional particles of the present invention (the functional particles in Examples 7 to 10 having the halogenated alkyl groups of 10 or more carbon atoms) were excellent both in oil-adsorbability and in dispersability. Further, those having aromatic groups as the hydrophobic moieties (in Examples 11 and 12) were also found to be excellent both in oil-adsorbability and in dispersability.

On the other hand, the particles having the halogenated alkyl groups of 6 or less carbon atoms (in Comparative Examples 4 and 5) poorly adsorbed the oil although they were excellent in dispersability.

TABLE 2

| | Ratio of un-adsorbed oil (%) | Dispersability |
|---|---|---|
| Ex. 7 | 2.9 | excellent |
| Ex. 8 | 2.6 | excellent |
| Ex. 9 | 1.2 | excellent |
| Ex. 10 | 0.9 | excellent |
| Ex. 11 | 2.8 | excellent |
| Ex. 12 | 2.7 | excellent |
| Com. 4 | 38.0 | poor |
| Com. 5 | 36.0 | poor |

1. Functional particles comprising magnetic particles and amphipathic groups loaded on the surfaces of said magnetic particles.

2. The functional particles according to claim 1, wherein said amphipathic groups are ammonium groups combined with hydrocarbon groups.

3. The functional particles according to claim 1, wherein said amphipathic groups are carboxylate groups combined with hydrocarbon groups.

4. The functional particles according to claim 1, wherein a hydrophobic group contained in said amphipathic groups are alkyl groups containing 8 or more carbon atoms.

5. The functional particles according to claim 1, wherein a hydrophobic group contained in said amphipathic groups are aromatic groups.

6. The functional particles according to claim 1, characterized by having a mean particle size of 0.1 to 1000 μm.

7. The functional particles according to claim 1, wherein said magnetic particles are magnetite.

8. The functional particles according to claim 1, characterized by being obtained by the steps of: reacting magnetic particles with a silane coupling agent containing alkoxysilyl groups and amino groups so as to treat the surfaces of the particles; and then reacting the particles with a halogenated hydrocarbon or a carboxylic acid so as to load amphipathic groups onto the surfaces of said particles.

9. The functional particles according to claim 8, wherein said silane coupling agent is 3-aminopropyltriethoxysilane.

10. The functional particles according to claim 8, wherein said magnetic particles are beforehand washed with alcohol before they are reacted with the silane coupling agent.

11. A water treatment method comprising:
dispersing the functional particles according to claim 1 in water containing impurities, so that said impurities are adsorbed on the surfaces of said functional particles; and then
collecting and recovering said functional particles having adsorbed the impurities by use of magnetic force.

12. The method according to claim 11, wherein said water containing impurities is industrial wastewater.

13. The method according to claim 11, wherein said functional particles having adsorbed the impurities are washed with at least one organic solvent selected from the group consisting of methanol, ethanol, n-propanol, iso-propanol, acetone, tetrahydrofuran, n-hexane, cyclohexane, and mixtures thereof, so that they are reclaimed and reused in the next water treatment.
